(19) United States
(12) Patent Application Publication
(10) Pub. No.: US 2005/0126328 A1
(43) Pub. Date: Jun. 16, 2005

(54) Rack and pinion steering gear adjuster clearance enhancement

(75) Inventors: Mark S. Piotrowski, Freeland, MI (US); Ronald J. Hansen, Frankenmuth, MI (US); Jason F. Gierman, Marlette, MI (US); William H. Georges, Saginaw, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: DELPHI TECHNOLOGIES INC.

(21) Appl. No.: 11/011,723

(22) Filed: Dec. 14, 2004

Related U.S. Application Data
(60) Provisional application No. 60/530,004, filed on Dec. 16, 2003.
(60) Provisional application No. 60/560,663, filed on Apr. 8, 2004.

(51) Int. Cl. F16H 1/04

(52) U.S. Cl. 74/492; 74/498

(57) ABSTRACT

The invention provides a steering assembly (10, 10a) including a first shaft (28, 28a) having a first longitudinal axis (29, 29a). The steering assembly (10, 10a) also includes a second shaft (32, 32a) having a second longitudinal axis (33, 33a). The first and second longitudinal axis (29, 29a, 33, 33a) are transverse and offset with respect one another. The first and second shafts (28, 28a, 32, 32a) are engaged at an intersection (35, 35a) such that the second shaft (32, 32a) translates along the second longitudinal axis (33, 33a) in response to rotation of the first shaft (28, 28a) about the first longitudinal axis (29, 29a). The steering assembly (10, 10a) also includes a bearing member (34, 34a, 34b, 34c) contacting the second shaft (32, 32a). The bearing member (34, 34a) is moveable along a bearing axis (37, 37a) extending transverse to both of the first and second longitudinal axis (33, 33a) at the intersection (35, 35a) to support the second shaft (32, 32a). The steering assembly (10, 10a) also includes an adjustment member (36, 36a, 36b) adjustably spaced from the bearing member (34, 34a, 34b, 34c) along the bearing axis (37, 37a). The adjustment member (36, 36a, 36b) limits movement of the bearing member (34, 34a, 34b, 34c) along the bearing axis (37, 37a). The steering assembly (10, 10a) also includes a post (40, 40a, 40b, 40c) disposed between the bearing member (34, 34a, 34b, 34c) and the adjustment member (36, 36a, 36b) along the bearing axis (37, 37a). The post (40, 40a, 40b, 40c) prevents the bearing member (34, 34a, 34b, 34c) and the adjustment member (36, 36a, 36b) from contacting one another.

### CROSS REFERENCE TO RELATED APPLICATIONS

This application claims the benefit of U.S. provisional patent application Ser. No. 60/530,004 for a RACK AND PINION STEERING GEAR ADJUSTER CLEARANCE ENHANCEMENT, filed on Dec. 16, 2003, and also claims the benefit of U.S. provisional patent application Ser. No. 60/560,663 for a RACK AND PINION STEERING GEAR ADJUSTER CLEARANCE ENHANCEMENT, filed on Apr. 8, 2004, both of which are hereby incorporated by reference in their entireties. This claim is made under 35 U.S.C. § 119(e); 37 C.F.R. § 1.78; and 65 Fed. Reg. 50093.

### FIELD OF THE INVENTION

The invention relates to a rack and pinion steering assembly for a vehicle and, more specifically, the invention relates to the interaction between a rack bearing and an adjustment plug in the rack and pinion steering assembly.

### BACKGROUND OF THE INVENTION

A rack and pinion steering assembly typically includes either a hydraulic steering valve or manual steering pinion, a rack and pinion housing assembly, a steering rack, a rack bearing, and an adjuster plug. The manual pinion or steering valve has one end positioned in the rack and pinion housing, while the gear end of the steering pinion engages with a steering rack. The steering rack in turn contacts the rack bearing. The interaction of the three components is basically as follows: The interaction between the steering rack and steering pinion is to convert rotational motion into linear movement. The rack bearing applies force to the back of the steering rack maintaining the proper mesh between the steering pinion's gear teeth and steering rack's rack teeth. The rack bearing's application of force is primarily utilized as a way to compensate for any dimensional discrepancies between the individual components. Therefore in the normal operation of the steering assembly the rack bearing reacts in a perpendicular manner relative to the steering rack's linear motion.

The steering rack and rack bearing are positioned in the housing between the steering pinion and the adjuster plug. A spring is positioned between the adjuster plug and the rack bearing. It is the spring's function to urge/force the rack bearing towards the steering rack and the steering rack towards the steering pinion. It is through this action that contact is maintained between the pinion teeth and the rack teeth. During assembly, the steering rack, the rack bearing, and the spring are inserted in their respective apertures defined by the R & P housing. The aperture for the adjuster plug is defined by the threaded opening in the R & P Housing, while the adjuster plug contains the mating threads. The adjuster plug engages via its threads with the opening of the aperture in the housing to compress the spring. The adjuster plug is rotated into the housing to a predetermined angular distance/force, to compress the spring and is then rotated in the reverse direction, a predetermined angular distance or clearance, to ensure that a predetermined gap is defined between the rack bearing and the adjuster plug. When the rack bearing and the adjuster plug contact one another during rotation of the steering rack, the rack bearing and the adjustment plug engage one another along opposing planar surfaces, especially around their perimeters. It is desirable to define a gap between the rack bearing and the adjustment plug to reduce the likelihood of frictional forces acting on the rack bearing that can result from sliding, relative contact between the adjustment plug and the rack bearing.

Currently, there are two primary methods used to set the adjuster plug back-off to establish the axial gap/clearance between the rack bearing and the adjuster plug. In the first method, the gear is assembled so that the following components are present in the housing: the steering rack, the hydraulic valve including a power pinion (or the manual pinion), the adjuster plug, the spring, and the rack bearing. The adjuster plug is then tightened in the aperture of the housing to compress the spring. The gear assembly is then “worn in” by manually stroking the gear to the full extent of its travel in both directions. The adjuster plug is then loosened and re-tightened to a predetermined amount of torque, usually 10 Nm. The adjuster plug is then rotated backwards or loosened by a predetermined angular amount. The turning torque of the gear is then tested.

In the second method used to set the adjuster plug back-off, the clearance is established using a direct measurement. The rack and pinion steering assembly is assembled so that the following components are present: the housing, the steering rack, the hydraulic valve including the power pinion assembly (or the manual pinion), the adjuster plug, the spring and the rack bearing. The adjuster plug is then tightened down and the gear assembly is worn in by manually stroking the gear to the full extent of its travel in both directions. The adjuster plug is then loosened. Next, a gauging device is attached directly to the housing, its indicator contacting either the steering rack or the rack bearing. The pinion is then torqued to a predetermined amount of torque and the total amount of displacement of the steering rack from its initial position is measured with the gauging device. If the amount of movement of the rack is not within a predetermined amount, the adjustment plug is readjusted to the proper clearance. The turning torque is then tested against a predetermined amount.

### SUMMARY OF THE INVENTION AND ADVANTAGES

The invention provides a steering assembly including a first shaft having a first longitudinal axis. The steering assembly also includes a second shaft having a second longitudinal axis. The first and second longitudinal axis are transverse and offset with respect one another. The first and second shafts are engaged at an intersection such that the second shaft translates along the second longitudinal axis in response to rotation of the first shaft about the first longitudinal axis. The steering assembly also includes a bearing member contacting the second shaft. The bearing member is moveable along a bearing axis extending transverse to both of the first and second longitudinal axis at the intersection to support the second shaft. The steering assembly also includes an adjustment member adjustably spaced from the bearing member along the bearing axis. The adjustment member limits movement of the bearing member along the bearing axis. The steering assembly also includes a post disposed between the bearing member and the adjustment member along the bearing axis. The post prevents the bearing member and the adjustment member from contacting one another.

The present invention provides a post extending between the rack bearing and the adjuster plug to more accurately define the gap between the adjuster plug and the rack bearing. The length of the post is sized to ensure that a gap exists between the rack bearing and the adjustment plug. The post also defines the contact area between the rack bearing and the adjustment plug. The contact area can be minimized to reduce the frictional forces resulting from sliding, relative contact between the adjuster plug and the rack bearing. The post can be integral with either the rack bearing or the adjuster plug. Or the post can be assembled with respect to either of the two parts.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a cross-sectional view of a first embodiment of the invention wherein a power rack and pinion assembly having a valve assembly and includes a post according to the present invention;

FIG. 2 is a cross-sectional view of a second embodiment of the invention wherein a manual rack and pinion gear assembly includes a post according to the present invention;

FIG. 3 is a cross-sectional view of a third embodiment of the invention showing a rack bearing and centering post integrally formed with respect to one another; and

FIG. 4 is an exploded view of a fourth embodiment of the invention wherein the centering post is assembled to one of the rack bearing and the adjustment plug.

### DETAILED DESCRIPTION OF THE PREFERRED EMBODIMENT

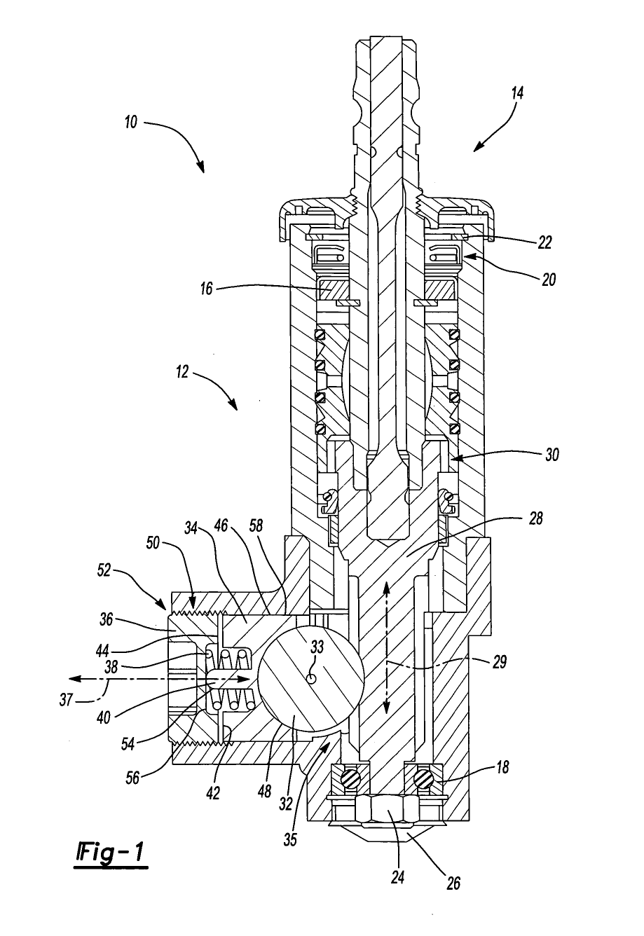

Referring now to FIG. 1, a steering assembly or power rack and pinion gear assembly 10 according to the exemplary embodiment of the invention includes a housing assembly 12 and a hydraulic valve and pinion assembly 14 received in the housing 12. The valve and pinion assembly 14 can be supported for rotation in the housing assembly 12 by first bearing 16 and the second bearing 18. The first bearing 16 can be an upper spool shaft bearing. The second bearing 18 can be a pinion bearing. A seal 20 and retaining clip 22 can be disposed at one end of the housing assembly 12 and a pinion nut 24 and dust cover 26 can be disposed at a second end of the housing assembly 12. The valve and pinion assembly 14 can include a first shaft or steering pinion 28 disposed in the housing assembly 12 adjacent the pinion nut 24 and dust cover 26. The first shaft 28 defines a first longitudinal axis 29. A second valve and pinion assembly 30 can be disposed between the seal 20 and the second bearing 18.

The steering pinion 28 can interact with a second shaft or steering rack 32 at an intersection 35, and the steering rack 32 can be supported by a bearing member or rack bearing 34. The bearing 34 is moveable along a bearing axis 37 and rotatable about the axis 37. The second shaft 32 defines a second longitudinal axis 33. The axis 29,33 are transverse and offset with respect to one another. The rack 32 translates along the axis 33 in response to rotation of the first shaft 28 about the axis 29. The steering rack 32 and rack bearing 34 are moveable in a direction transverse to the steering pinion 28 and rotatable. The steering rack 32 and rack bearing 34 are biased towards the steering pinion 28 by an adjustment member or adjuster plug 36 and a a biasing member or spring 38. A post 40 is disposed between the rack bearing 34 and the adjuster plug 36. The post 40 dictates where the first point of contact will occur. Additionally, it is the post 40, which ensures a gap or clearance is defined between the rack bearing 34 and the adjustment plug 36. In particular, the post 40 is sized to ensure that a space is defined between a first surface or face surface 42 of the rack bearing 34 and a second surfaces or second face surface 44 of the adjustment plug 36. The post 40 can be integrally formed with respect to either the rack bearing 34 or the adjustment plug 36. Alternatively, the post 40 can be assembled to either the rack bearing 34 or the adjustment plug 36. The post 40 can be incorporated in any manual rack and pinion steering gear assembly, any power rack and pinion gear assembly (both center take-off and end take-off designs), quadrasteer assemblies, electric power steering gear assemblies, steering gears with Y-shaped steering racks, steering gears with rounded steering racks, steering gears with hollow steering racks, and steering gears with solid steering racks.

During assembly of the rack and pinion gear assembly 10, the steering rack 32 is inserted in an aperture 46 defined by the housing assembly 12. The rack bearing 34 is inserted in the aperture 46 and a receiving surface 48 engages the steering rack 32. In the exemplary embodiment of the invention, the post 40 is integrally formed with the rack bearing 34 and is defined on an opposite side of the rack bearing 34 relative to the receiving surface 48. The spring 38 is positioned over the post 40 and encircles the post 40. Threads 50 of the adjustment plug 36 are engaged with threads 52 defined by the aperture 46 and the adjustment plug 36 is rotated in a first angular direction to move the plug 36 into the aperture 46, in the direction of the steering pinion 28.

The plug 36 is rotated in the first angular direction a first predetermined angular distance or a first predetermined level of torque. The first predetermined angular distance can correspond to a position wherein a tip 54 of the post 40 engages a surface 56 of the adjustment plug 36. When the tip 54 engages the surface 56, a clearance or gap will be defined between the surfaces 42, 44. After the adjustment plug 36 has been rotated the first predetermined angular distance, the plug 36 can be rotated in a second angular direction a second predetermined angular distance. The second predetermined angular distance can correspond to the desired amount of travel of the steering rack 32 and rack bearing 34 in the aperture 46 relative to the adjustment plug 36. In other words, it is not desirable for the tip 54 to engage and disengage the surface 56 during operation of the assembly 10.

It is believed that the positioning of the post 40 between the adjustment plug 36 and the rack bearing 34 reduces several different types of noise observed in rack and pinion steering gear assemblies. In particular, it has been observed that noise can be generated when the rack bearing 34 and the adjustment plug 36 contacts along surfaces 44 and 42 and then move relative to one another. The post 40 prevents the surfaces 42, 44 from directly engaging one another. Furthermore, the tip 54 of the post 40 defines a smaller contact area between the rotatable rack bearing 34 and the adjustment plug 36 than the surfaces 42, 44.

As a result of manufacturing tolerances, the surfaces 42, 44 are not perfectly flat or square. Sliding contact between the surfaces 42, 44 can induce moments with respect to the rack bearing 34, urging the rack bearing 34 to wobble about its longitudinal axis during rotation. It has been observed that noise can be generated when a portion outer surface 58 of the rack bearing 34 engages in sliding contact with the aperture 46 as a result of a moment generated from sliding contact between the surfaces 42, 44. In other words, particular portions of the outer surface 58 exert greater forces against the aperture 46 than other portions of the outer surface 58. It is believed that the post 40 substantially reduces the likelihood that a moment will be generated that tends to urge the rack bearing 34 to wobble and substantially eliminates the noise associated with rack bearing 34 wobble.

It is also been observed that the noise associated with relative movement between the rack bearing 34 and the steering rack 32 is reduced when the post 40 is positioned between the rack bearing 34 and the adjustment plug 36. It is believed that the post 40 decreases the sensitivity of the steering assembly 14 to the steering rack 34 rotating about its longitudinal axis. Similarly, it is believed that the post 40 reduces the likelihood that the rack bearing 34 will induce noise-generating intermittent contact between the steering rack 32 and the steering pinion 28.

It has also been observed that the torque required for turning the pinion 28 and housing assembly 12 is more consistent when the post 40 is disposed between the rack bearing 34 and the adjustment plug 36. It is believed that the enhanced torque consistency results from the reduced surface area over which the rack bearing 34 and the adjustment plug 36 contacts one another.

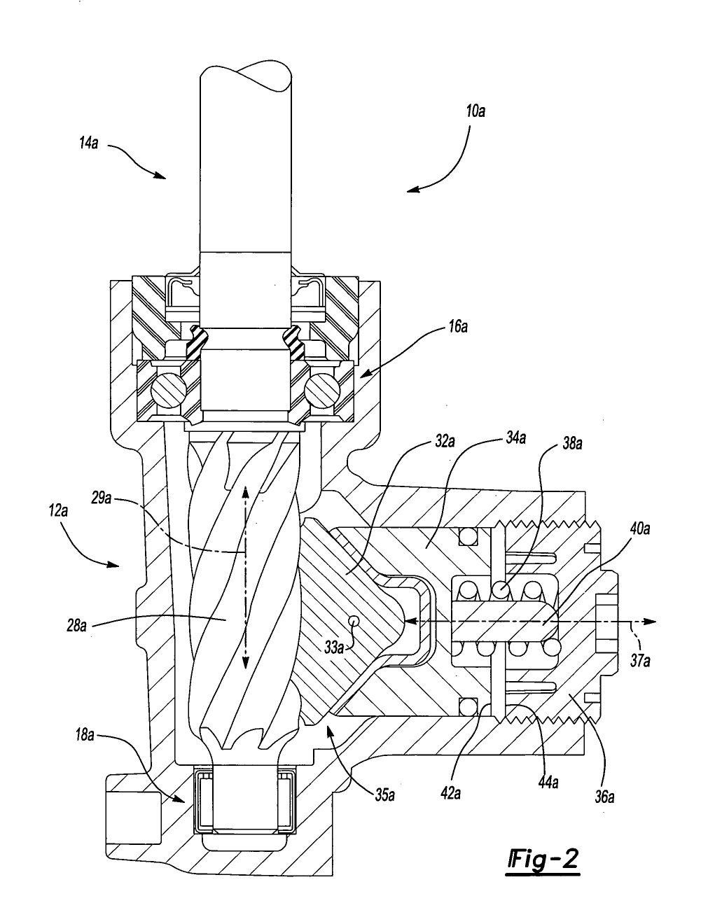

Referring now to FIG. 2, a manual rack and pinion gear assembly 10a according to a second exemplary embodiment of the invention includes a housing assembly 12a and a pinion assembly 14a received in the housing 12a. The pinion assembly 14a can be supported for rotation in the housing assembly 12a by first bearing 16a and the second bearing 18a. The pinion assembly 14a can include a steering pinion 28a disposed in the housing assembly 12a. The first shaft 28a defines a first longitudinal axis 29a.

The steering pinion 28a can interact with a steering rack 32a at an axis 35a, and the steering rack 32a can be supported by a rack bearing 34a. The second shaft 32a defines a second longitudinal axis 33a. The axis 29a,33a are transverse and offset with respect to one another. The steering rack 32a and rack bearing 34a are moveable in a direction transverse to the steering pinion 28a and rotatable. The steering rack 32a and rack bearing 34a are biased towards the steering pinion 28a by an adjustment plug 36a and a spring 38a. The bearing 34a is moveable along a bearing axis 37a and rotatable about the axis 37a.

A post 40a is disposed between the rack bearing 34a and the adjustment plug 36a. The post 40 dictates where the first point of contact will occur. Additionally, it is post 40a, which ensures a gap or clearance is defined between the rack bearing 34a and the adjustment plug 36a. In particular, the post 40a is sized to ensure that a space is defined between a face surface 42a of the rack bearing 34a and a face surface 44a of the adjustment plug 36a. The post 40a can be integrally formed with respect to either of the rack bearing 34a or the adjustment plug 36a. Alternatively, the post 40a can be assembled to either of the rack bearing 34a or the adjustment plug 36a.

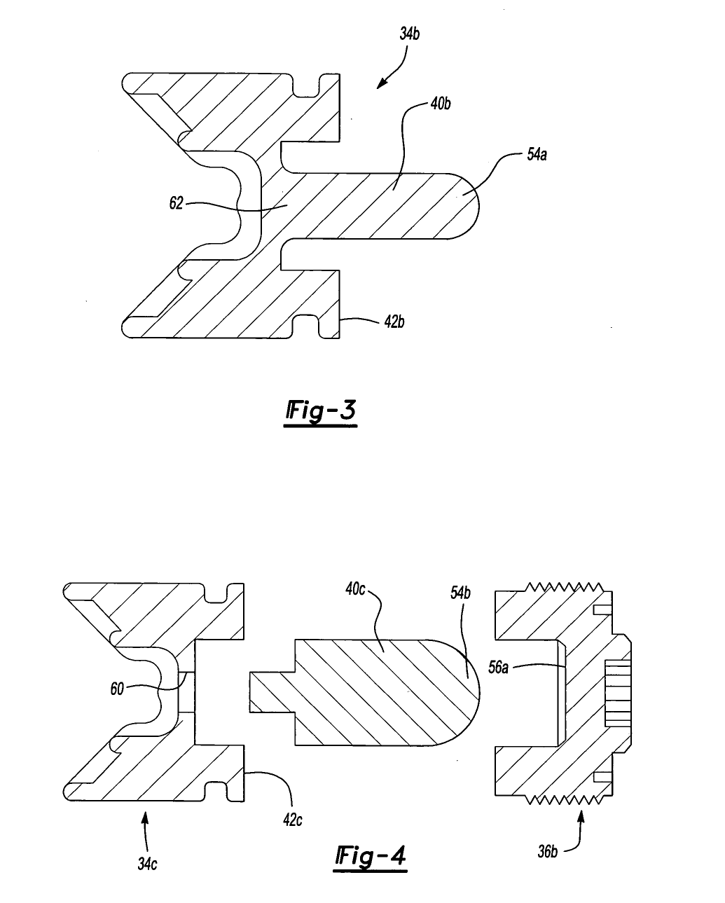

Referring now to FIG. 3, a rack bearing 34b according to a third exemplary embodiment of the invention includes a post 40b. The post 40b is integrally formed with respect to the rack bearing 34b. The post 40b extends past a surface 42b to a tip 54a. The tip 54a may be rounded to minimize a contact area between the post 40b and an adjustment plug (not shown).

Referring now to FIG. 4, a rack bearing 34c according to a fourth exemplary embodiment of the invention is assembled to a post 40c. The rack bearing 34c defines an aperture 60 for receiving a portion 62 of the post 40c. When assembled to the rack bearing 34c, the post 40c extends past a surface 42c to a tip 54b. The tip 54b may be rounded to minimize a contact area between the post 40c and a surface 56a of an adjustment plug 36b.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A steering assembly (10, 10a) comprising:
a first shaft (28, 28a) having a first longitudinal axis (29, 29a);
a second shaft (32, 32a) having a second longitudinal axis (33, 33a) transverse and offset with respect to said first longitudinal axis (29, 29a), said first and second shafts (28, 28a, 32, 32a) engaged at an intersection (35, 35a) wherein said second shaft (32, 32a) translates along said second longitudinal axis (33, 33a) in response to rotation of said first shaft (28, 28a) about said first longitudinal axis (29, 29a);
a bearing member (34, 34a, 34b, 34c) contacting said second shaft (32, 32a) and moveable along a bearing axis (37, 37a) extending transverse to both of said first and second longitudinal axis (33, 33a) at said intersection (35, 35a) to support said second shaft (32, 32a);
an adjustment member (36, 36a, 36b) adjustably spaced from said bearing member (34, 34a, 34b, 34c) along said bearing axis (37, 37a) and limiting movement of said bearing member (34, 34a, 34b, 34c) along said bearing axis (37, 37a); and
a post (40, 40a, 40b, 40c) disposed between said bearing member (34, 34a, 34b, 34c) and said adjustment member (36, 36a, 36b) along said bearing axis (37, 37a) and preventing said bearing member (34, 34a, 34b, 34c) and said adjustment member (36, 36a, 36b) from contacting one another.

2. The steering assembly (10, 10a) of claim 1 wherein said post (40, 40a, 40b, 40c) engages one of said bearing member (34, 34a, 34b, 34c) and said adjustment member (36, 36a, 36b) with a rounded tip (54, 54a, 54b).

3. The steering assembly (10, 10a) of claim 1 wherein said post (40, 40a, 40b, 40c) is centered on said bearing axis (37, 37a).

4. The steering assembly (10, 10a) of claim 1 wherein said post (40, 40a, 40b, 40c) is connected to one of said bearing member (34, 34a, 34b, 34c) and said adjustment member (36, 36a, 36b).

5. The steering assembly (10, 10a) of claim 1 wherein:
said bearing member (34, 34a, 34b, 34c) includes a receiving surface (48) contacting said second shaft (32, 32a) and a first surface (42, 42a, 42b, 42c) facing away from said second shaft (32, 32a); and
said adjustment member (36, 36a, 36b) includes a second surface (44, 44a) facing said first surface (42, 42a, 42b, 42c), wherein said post (40, 40a, 40b, 40c) prevents said first and second surfaces (42, 42a, 42b, 42c, 44, 44a) from contacting one another.

6. The steering assembly (10, 10a) of claim 5 wherein said post (40, 40a, 40b, 40c) is radially spaced from both of said first and second surfaces (42, 42a, 42b, 42c, 44, 44a).

7. The steering assembly (10, 10a) of claim 5 wherein at least one of said first and second surfaces (42, 42a, 42b, 42c, 44, 44a) encircle said post (40, 40a, 40b, 40c).

8. The steering assembly (10, 10a) of claim 7 wherein both of said first and second surfaces (42, 42a, 42b, 42c, 44, 44a) encircle said post (40, 40a, 40b, 40c).

9. The steering assembly (10, 10a) of claim 1 wherein said bearing member (34, 34a, 34b, 34c) is rotatable about said bearing axis (37, 37a) and moveable along said bearing axis (37, 37a).

10. The steering assembly (10, 10a) of claim 9 wherein said adjustment member (36, 36a, 36b) is adjustable to a fixed position with respect to translation and rotation relative to said bearing axis (37, 37a).

11. The steering assembly (10, 10a) of claim 1 further comprising:
a spring (38, 38a) biasing said bearing member (34, 34a, 34b, 34c) and said adjustment member (36, 36a, 36b) apart from one another and encircling said post (40, 40a, 40b, 40c).

12. A steering assembly (10, 10a) comprising:
a housing (12, 12a) having an interior and aperture (46);
a first shaft (28, 28a) having a first longitudinal axis (29, 29a) and at least partially disposed in said housing (12, 12a);
a second shaft (32, 32a) having a second longitudinal axis (33, 33a) transverse and offset with respect to said first longitudinal axis (29, 29a), said first and second shafts (28, 28a, 32, 32a) engaged in worm relationship at an intersection (35, 35a) wherein said second shaft (32, 32a) translates along said longitudinal axis in response to rotation of said first shaft (28, 28a), said intersection (35, 35a) positioned in said housing (12, 12a);
a bearing member (34, 34a, 34b, 34c) disposed in said aperture (46) and contacting said second shaft (32, 32a) and moveable along a bearing axis (37, 37a) extending transverse to both of said first and second shafts (28, 28a, 32, 32a) at said intersection (35, 35a) to support said second shaft (32, 32a);
an adjustment member (36, 36a, 36b) adjustably spaced from said bearing member (34, 34a, 34b, 34c) along said bearing axis (37, 37a) in said aperture (46) and limiting movement of said bearing member (34, 34a, 34b, 34c) along said bearing axis (37, 37a); and
a post (40, 40a, 40b, 40c) disposed between said bearing member (34, 34a, 34b, 34c) and said adjustment member (36, 36a, 36b) along said intersection (35, 35a) action and preventing said bearing member (34, 34a, 34b, 34c) and said adjustment member (36, 36a, 36b) from contacting one another.

13. The steering assembly (10, 10a) of claim 12 wherein said bearing member (34, 34a, 34b, 34c) is slidably engaged with said aperture (46), being rotatable about said bearing axis (37, 37a) and moveable along said bearing axis (37, 37a).

14. The steering assembly (10, 10a) of claim 13 wherein said adjustment member (36, 36a, 36b) is fixed along said intersection (35, 35a) after adjustment and said post (40, 40a, 40b, 40c) prevents said bearing member (34, 34a, 34b, 34c) from slidably engaging said adjustment member (36, 36a, 36b).

15. The steering assembly (10, 10a) of claim 14 wherein said post (40, 40a, 40b, 40c) defines a rounded surface engageable with one of said bearing member (34, 34a, 34b, 34c) and said adjustment member (36, 36a, 36b).

16. The steering assembly (10, 10a) of claim 15 wherein said one of said bearing member (34, 34a, 34b, 34c) and said adjustment member (36, 36a, 36b) defines a planar surface (56) engageable with said rounded surface.

17. The steering assembly (10, 10a) of claim 12 wherein said post (40, 40a, 40b, 40c) is integrally formed with one of bearing member (34, 34a, 34b, 34c) and said adjustment member (36, 36a, 36b).

18. The steering assembly (10, 10a) of claim 12 wherein said post (40, 40a, 40b, 40c) is releasibly engaged with one of bearing member (34, 34a, 34b, 34c) and said adjustment member (36, 36a, 36b).

19. The steering assembly (10, 10a) of claim 12 further comprising:
a biasing member (38, 38a) disposed between said bearing member (34, 34a, 34b, 34c) and said adjustment member (36, 36a, 36b) and urging said bearing member (34, 34a, 34b, 34c) and said adjustment member (36, 36a, 36b) apart, said biasing member encircling said post (40, 40a, 40b, 40c).

20. A steering assembly (10, 10a) comprising:
a housing (12, 12a) having an interior and aperture (46);
a first shaft (28, 28a) having a first longitudinal axis (29, 29a) and supported by said housing (12, 12a) for rotation about said first longitudinal axis (29, 29a);
a second shaft (32, 32a) having a second longitudinal axis (33, 33a) transverse and offset with respect to said first longitudinal axis (29, 29a), said first and second shafts (28, 28a, 32, 32a) engaged in worm relationship at an intersection (35, 35a) wherein said second shaft (32, 32a) translates along said second longitudinal axis (33, 33a) in response to rotation of said first shaft (28, 28a) about said first longitudinal axis (29, 29a) said second shaft (32, 32a) supported by said housing (12, 12a) for translation along said second longitudinal axis (33, 33a);
a bearing member (34, 34a, 34b, 34c) disposed in said housing (12, 12a) and contacting said second shaft (32, 32a) and moveable along a bearing axis (37, 37a) extending transverse to both of said first and second longitudinal axis (33, 33a) at said intersection (35, 35a) to support said second shaft (32, 32a);
an adjustment member (36, 36a, 36b) disposed in said housing (12, 12a) and adjustably spaced from said bearing member (34, 34a, 34b, 34c) along said bearing axis (37, 37a) and limiting movement of said bearing member (34, 34a, 34b, 34c) along said bearing axis (37, 37a); and
a post (40, 40a, 40b, 40c) disposed between said bearing member (34, 34a, 34b, 34c) and said adjustment member (36, 36a, 36b) along said intersection (35, 35a) action and preventing said bearing member (34, 34a, 34b, 34c) and said adjustment member (36, 36a, 36b) from contacting one another, a point contact defined between said post (40, 40a, 40b, 40c) and said adjustment member (36, 36a, 36b) when said post (40, 40a, 40b, 40c) and said adjustment member (36, 36a, 36b) contact one another.
